(19) United States
(12) Patent Application Publication
(10) Pub. No.: US 2025/0279884 A1
(43) Pub. Date: Sep. 4, 2025

(54) METHODS AND SYSTEMS FOR SECURE KEY DISPERSAL

(71) Applicant: Arash Esmailzadeh, Los Angeles, CA (US)

(72) Inventor: Arash Esmailzadeh, Los Angeles, CA (US)

(73) Assignee: Arash Esmailzadeh, Los Angeles, CA (US)

(21) Appl. No.: 19/067,639

(22) Filed: Feb. 28, 2025

Related U.S. Application Data
(60) Provisional application No. 63/559,334, filed on Feb. 29, 2024.

(51) Int. Cl. H04L 9/08; G06K 19/06

(52) U.S. Cl. CPC H04L 9/088; G06K 19/06037

(57) ABSTRACT

Techniques of securely storing and managing a private key may include receiving, by an application executing on a computerized device, the private key. The application may divide the private key into two or more shares such that at least two shares of the two or more shares are required to perform transactions associated with the private key. The application may then divide the private key and a first share of the two or more shares into at least three sub-shares such that at least a threshold number of two or more sub-shares of the at least three sub-shares are required to reconstruct the private key, the first share, or both. The application may further encode at least one of the at least three shares as quick response (QR) code images.

### CROSS REFERENCE TO RELATED APPLICATIONS

This application claims the benefit of, and priority to U.S. Provisional Application No. 63/559,334 (including an Appendix), filed on Feb. 29, 2024, which is hereby incorporated by reference in its entirety for all purposes.

### BACKGROUND

The increasing adoption of blockchain technology underscores the critical need for improved methods and systems for securely storing private keys. As digital assets become more mainstream, the potential risks associated with storing private keys, which are the primary means of controlling and accessing these assets, become more pronounced. Traditional methods of private key storage, such as software wallets and exchanges, are vulnerable to various security threats, including hacking, phishing, and insider attacks. Moreover, the irreversible nature of blockchain transactions means that any compromise of private keys can lead to permanent loss of funds. Therefore, there is a pressing need for innovative solutions that offer robust protection against unauthorized access, loss, or theft of private keys while ensuring ease of use and accessibility for users.

### SUMMARY

In some embodiments, a method of securely storing and managing a private key may include receiving, by an application executing on a computerized device, the private key. The method may also include dividing, by the application, the private key into two or more shares such that at least two shares of the two or more shares are required to perform transactions associated with the private key. The method may additionally include dividing, by the application, the private key and a first share of the two or more shares into at least three sub-shares such that at least a threshold number of two or more sub-shares of the at least three sub-shares are required to reconstruct the private key, the first share, or both. The method may further include encoding, by the application, at least one of the at least three shares as quick response (QR) code images.

In some embodiments, one or more non-transitory computer-readable media may include instructions that, when executed by one or more processors, cause the one or more processors to perform operations including receiving, by an application executing on a computerized device, the private key. The operations may also include dividing, by the application, the private key into two or more shares such that at least two shares of the two or more shares are required to perform transactions associated with the private key. The operations may additionally include dividing, by the application, the private key and a first share of the two or more shares into at least three sub-shares such that at least a threshold number of two or more sub-shares of the at least three sub-shares are required to reconstruct the private key, the first share, or both. The operations may further include encoding, by the application, at least one of the at least three shares as quick response (QR) code images.

In some embodiments, a system may include one or more processors and one or more storage devices storing instructions that, when executed by the one or more processors, cause the one or more processors to perform operations including receiving, by an application executing on a computerized device, the private key. The operations may also include dividing, by the application, the private key into two or more shares such that at least two shares of the two or more shares are required to perform transactions associated with the private key. The operations may additionally include dividing, by the application, the private key and a first share of the two or more shares into at least three sub-shares such that at least a threshold number of two or more sub-shares of the at least three sub-shares are required to reconstruct the private key, the first share, or both. The operations may further include encoding, by the application, at least one of the at least three shares as quick response (QR) code images.

In any embodiments, any and/or all of the following features may be implemented in any combination and without limitation. A digital file may be generated that includes a representation of at least one of the QR code images for exporting off of the computerized device. At least one of the at least three shares may be stored in a memory of the computerized device. The method/operations may also include receiving, at a user interface provided by the application, a request to access a wallet associated with a user of the computerized device, where access to the wallet may require the private key or a combination of the two or more shares generated by dividing the private key. The method/operations may additionally include scanning, by the application, and in response to receiving the request, a subset of the QR code images. The method/operations may further include decoding, by the application, each of the subset of the QR code images to extract a respective sub-share of the first share. The method/operations may also include determining, by the application, and based on information from each respective sub-share, that the plurality of QR codes represents a minimum number of sub-shares required to recover the first share. The method/operations may additionally include combining, by the application, each respective sub-share to reconstruct the first share. The method/operations may further include using, by the application, the reconstructed first share with the second share to access the wallet. Scanning the plurality of QR codes may include capturing a digital image of at least one of the QR codes using a camera connected to the computerized device. Scanning the plurality of QR codes may include receiving, via the user interface, a selection of a digital file from a file system accessible on the computerized device to the application; and determining, by the application, that the digital file comprises a representation of at least one of the QR codes.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates an exemplary architecture for private key dispersal, according to some embodiments.

FIG. 2 illustrates the various development steps associated with integrating a wallet service provider's application with various third-party services and/or external technologies, according to some embodiments.

FIG. 3 illustrates a managed share and a device share that may be created from a user's private key, according to some embodiments.

FIG. 4 illustrates a sample flow a user may follow to generate multiple Quick Response (QR) codes, according to some embodiments.

FIG. 5 illustrates a grid of additional or alternative storage options for the QR code shares, according to some embodiments.

FIG. 6 illustrates a user flow whereby, when importing a wallet to a wallet management application, the private key used to access the wallet may be recovered by scanning or importing the threshold number of QR code shares into the application, according to some embodiments.

FIG. 7 illustrates a method of securely storing and managing a private key, according to some embodiments.

FIG. 8 illustrates a method of decoding a private key, according to some embodiments.

FIG. 9 illustrates an exemplary controller, in which various embodiments may be implemented.

### DESCRIPTION

Decentralized applications (DApps) are software applications that operate on a decentralized network of computers rather than a single central server. They utilize blockchain technology to enable peer-to-peer interactions without the need for intermediaries. DApps typically have their backend code running on a decentralized peer-to-peer network, such as Ethereum or EOS, and use smart contracts to automate certain functions and ensure trustless execution. Users interact with DApps through front-end interfaces, which can be web-based or mobile applications. These applications offer various benefits, including increased security, transparency, and censorship resistance. Examples of decentralized applications range from decentralized finance (DeFi) platforms for lending and trading to decentralized social media networks and gaming platforms.

Blockchain wallets are digital tools that allow users to store, manage, and interact with their cryptocurrency assets securely on a blockchain network. Each wallet contains a pair of cryptographic keys: a public key (wallet address) and a private key. The public key is akin to an account number and is used for receiving packets, while the private key is like a password and is used to access and authorize transmissions from the wallet. Blockchain wallets can be categorized into two main types: hot wallets and cold wallets. Hot wallets are connected to the internet and are suitable for frequent transactions and easy access, such as software wallets (desktop, mobile, or online) and exchange wallets. Cold wallets, on the other hand, are offline storage solutions, providing enhanced security by keeping the private keys offline, away from potential hacking attempts. Cold wallets include hardware wallets (physical devices) and paper wallets (physical documents containing the private key information). Blockchain wallets facilitate sending, receiving, and managing various tokens, offering users control over their digital assets outside traditional systems.

A private key in the context of cryptography and blockchain is a unique, confidential, and cryptographically secure piece of data that allows an individual to access and control their holdings stored in a blockchain wallet. It is essentially a long string of alphanumeric characters generated using cryptographic algorithms. The private key is paired with a public key to form a key pair, where the public key is derived from the private key. While the public key is openly shared and used to receive transmissions, the private key must be kept secret and known only to the owner. This key is crucial for signing transactions on the blockchain, proving ownership of assets, and authorizing transfers from the associated wallet address. The security of a private key is paramount, as anyone who gains access to it can potentially access and control the funds associated with the corresponding wallet address. Therefore, it's essential to store private keys securely and never share them with others. Various wallet types, such as hardware wallets and paper wallets, are designed to safeguard private keys from unauthorized access and potential cyber threats.

Wallet service providers are companies or platforms that offer wallet solutions to individuals and businesses, allowing them to securely store, manage, and transact with their digital assets. These providers typically offer a range of wallet types, including software wallets (such as desktop, mobile, or web-based wallets), hardware wallets, and custodial wallets. Software wallets are applications or programs installed on devices like computers or smartphones, enabling users to access their funds conveniently. Hardware wallets are physical devices designed specifically for storing private keys offline, providing enhanced security against hacking attempts. Custodial wallets, on the other hand, involve the wallet service provider holding the private keys on behalf of the user, allowing for easier access and recovery but relinquishing some control over the assets and increasing potential attack vectors. Wallet service providers may manage private keys in a number of different ways.

Private key management encompasses the practices and procedures individuals or entities employ to securely handle, store, and utilize private keys, particularly in the realm of blockchain systems. It involves ensuring the secure generation of keys using reliable cryptographic methods and random number generation, storing them safely to prevent unauthorized access or theft, creating backups and recovery mechanisms to guard against loss, implementing access controls to restrict key access to authorized parties, conducting regular audits and monitoring activities to detect and mitigate security risks, periodically rotating keys to enhance security, and employing proper procedures for disposal or destruction when keys are no longer needed. By implementing a combination of technical, procedural, and organizational measures, effective private key management aims to safeguard digital assets and mitigate the risk of unauthorized access or loss throughout the key lifecycle.

Private key storage involves securely managing cryptographic private keys, crucial for controlling and accessing digital assets in blockchain and other systems. Methods include hardware wallets, specialized physical devices storing keys offline for heightened security, software wallets installed on digital devices, paper wallets where keys are printed on physical paper for offline storage, secure storage devices like encrypted USB drives, and cryptographic vault services offering advanced security features.

Seed phrases, also known as mnemonic phrases or recovery phrases, are a standardized way of representing and storing the private keys that control digital wallets. Typically made up of a series of 12 to 24 words chosen from a predefined list, seed phrases serve as a human-readable backup mechanism for wallet owners. These phrases are generated using cryptographic algorithms and are capable of generating an entire hierarchical deterministic (HD) wallet, allowing users to recover their wallet and funds in case of loss, theft, or hardware failure. The order and combination of words in the seed phrase are crucial, as they determine the private keys and addresses associated with the wallet. Seed phrases offer a convenient and user-friendly way to back up and restore cryptocurrency wallets securely, without the need to store or manage complex cryptographic keys directly. However, if used as the only form of private key storage, it becomes imperative to keep the seed phrases confidential and secure, as anyone with access to the phrase can potentially gain control over the associated cryptocurrency funds, and once lost or forgotten, it may no longer be possible to recover the private key.

Concerns associated with single factor private key recovery architectures, such as those that rely on seed phrases alone for recovery, may be addressed using private key dispersal. Private key dispersal involves splitting a cryptographic private key into multiple components or shares distributed among different entities or locations, adding an extra layer of security to the key management process. This method may be employed in multi-party cryptographic protocols or schemes, such as threshold cryptography or secret sharing. In private key dispersal, each share alone does not reveal any information about the original key, but when a sufficient number of shares are combined, the original private key can be reconstructed. This approach mitigates the risk associated with a single point of failure, as an attacker would need to compromise multiple entities or locations to reconstruct the private key. Private key dispersal can enhance security and resilience in scenarios where key compromise or loss must be minimized, such as in cryptographic key management systems or decentralized control of assets.

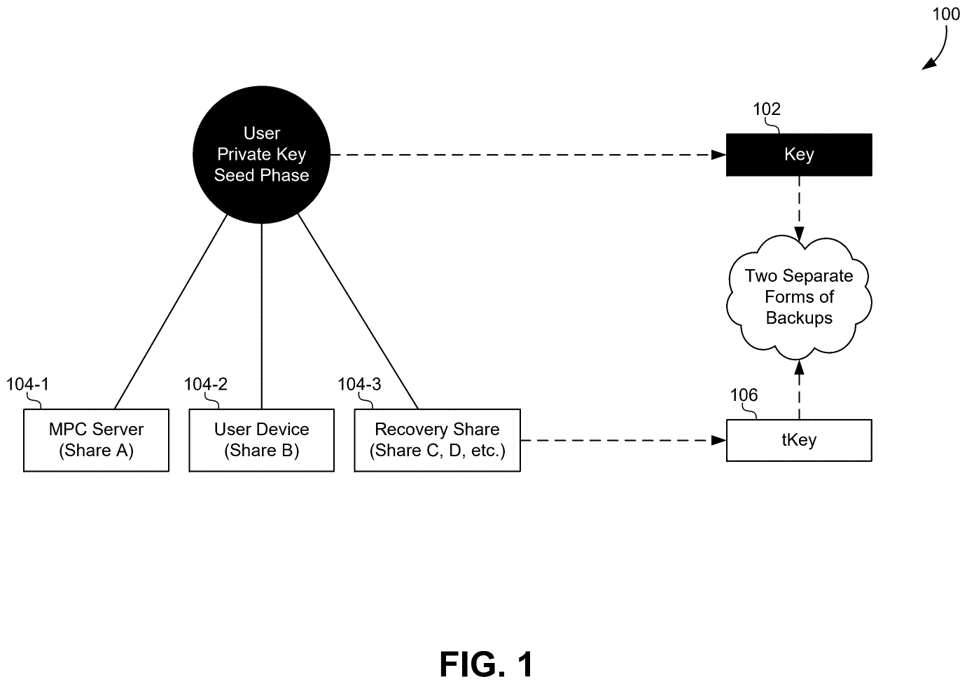

FIG. 1 illustrates an exemplary architecture 100 for private key dispersal, according to some embodiments. As illustrated, a user's private key 102 may be split into three or more distinct shares 104 (e.g., components or factors) across different entities, devices, and/or locations. For example, one share 104-2 (e.g., “Share B”) may be stored on a computing device commonly used to access a DApp, blockchain wallet, or the like. Such a share 104-2 may be stored, for example, in device storage that's secured with biometrics. Another share 104-3 (e.g., “Share C”) may serve as a recovery share that a user can keep on a separate device, download, or base on user input with sufficient entropy. This could include a password, security questions, or a hardware device, among other options.

As another example, a share 104-1 (e.g., “Share A”) may be managed by a service and/or stored across multiple nodes in an authentication network. Such a share 104-1 may be divided into sub-shares, each for distribution to a distinct node. A threshold number of sub-shares may be required to recreate the overall share to mitigate the risk of any one node becoming compromised. In some embodiments, a user may access a managed share by authenticating their credentials with a separate provider, such as an Open Authorization (OAuth) provider.

While referred to as managed shares, device shares, recovery shares, or the like, each of the shares 104 may represent a threshold key, or tKey 106, of a private key or other similar protected information. Additionally, or alternatively, the term tKey 106 may refer to a single share that is managed by, or otherwise in the custody of, a user, such as a device share stored on a user's device, or a recovery. Alone, tKeys are undecipherable, meaning that the information represented by a tKey 106 is indistinguishable from random values and cannot be used to recover the private key or other protected information absent one or more additional shares or tKeys. The number of shares 104 in addition to the tKey 106 that are required to recover a private key 102, or other protected information, may be less than the total number of shares that are generated from the private key 102. For example, to recover a private key, or sign transactions using multi-party computation (MPC) as described below, a threshold number of tKeys must be combined using one or more cryptographic algorithms.

OAuth providers are services or platforms that implement the OAuth protocol to enable secure authorization and authentication for third-party applications. OAuth is an open standard for access delegation, commonly used by applications and websites to allow users to grant access to their information or resources stored on one platform to another platform without sharing their credentials (such as usernames and passwords). OAuth providers typically manage user identities and permissions, acting as intermediaries between users and third-party applications. When a user wants to access a third-party application using their existing credentials from an OAuth provider, the application redirects the user to the OAuth provider's authentication server. The user then logs in using their credentials or grants permission for the application to access their data. Upon successful authentication or authorization, the OAuth provider issues a token to the application, which it can use to access the user's resources on behalf of the user. Using this token, a threshold number of sub-shares of a managed share of a private key can be retrieved from corresponding nodes in a distributed network and used to recover the managed share of the private key 102. Popular OAuth providers include social media platforms, as well as dedicated identity management services like Auth0 and Okta.

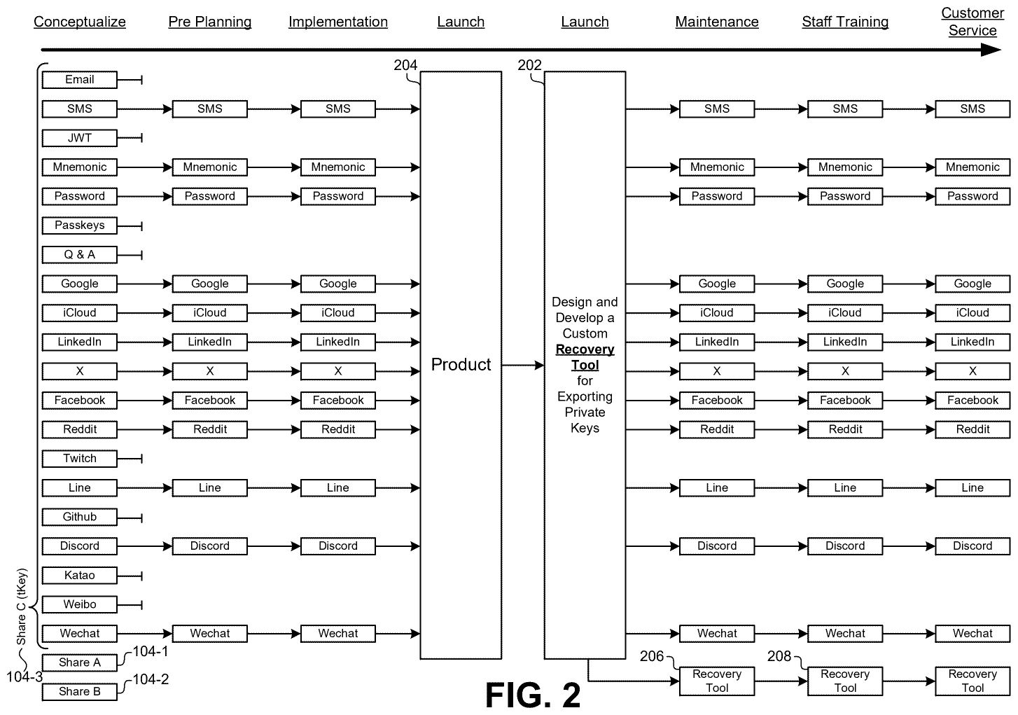

However, using OAuth providers, or other credential authentication services, to control access to a managed share can quickly become cost prohibitive for wallet service providers due to the amount of time needed to integrate with an endlessly growing list of authentication service. FIG. 2 illustrates the various development steps associated with integrating a wallet service provider's application with various third-party services and/or external technologies, according to some embodiments. Notably, a custom tool 202 for exporting and recovering private keys must be designed and developed to handle recovery of shares from the various integrated service 204. In addition, wallet service providers would have to dedicate a significant amount of time and effort maintaining 206 their product as each integrated service is updated. Further, staff must be trained 208 on each service and customer service must be tailored to address possible issues unique to each service. Lastly, using authentication services leaves open the possibility that a compromised service could gain access to the managed share, making the private share more readily accessible.

Multi-party computation (MPC) is a cryptographic technique that enables multiple parties to jointly compute a function over their private inputs without revealing those inputs to each other. In MPC, each party holds its own private input data and collaborates with others to compute a desired function or result without disclosing any sensitive information. This is achieved through cryptographic protocols that ensure privacy, security, and correctness of the computation. MPC protocols typically involve multiple rounds of communication and computation among the parties, during which they exchange encrypted messages and perform cryptographic operations to jointly compute the desired function.

MPC allows parties to collaborate on computations while maintaining the confidentiality and integrity of their private data, such as a user's private key. For example, instead of reconstructing a user's private key from a threshold number of shares created from the private key, MPC can allow applications to perform transactions using the threshold number of shares without actually reconstructing the private key in a single place.

Using private key dispersal and MPC can allow wallet service providers, and their user-facing applications, to avoid subsequent reconstruction of a user's private key at any one location, or on any one device, thereby further improving its security while still enabling users to access their wallets in the event that one of their shares is lost or forgotten. However, while these approaches may improve security, they can frustrate an appealing aspect of blockchain technology, which is that of shifting the control from institutions to the user's hands. For example, by providing an application that only uses shares to sign transactions, and not to reconstruct private keys, the private keys are effectively held hostage by the wallet service provider unless users store a copy of their private keys elsewhere or the wallet service provider implements a separate recovery tool.

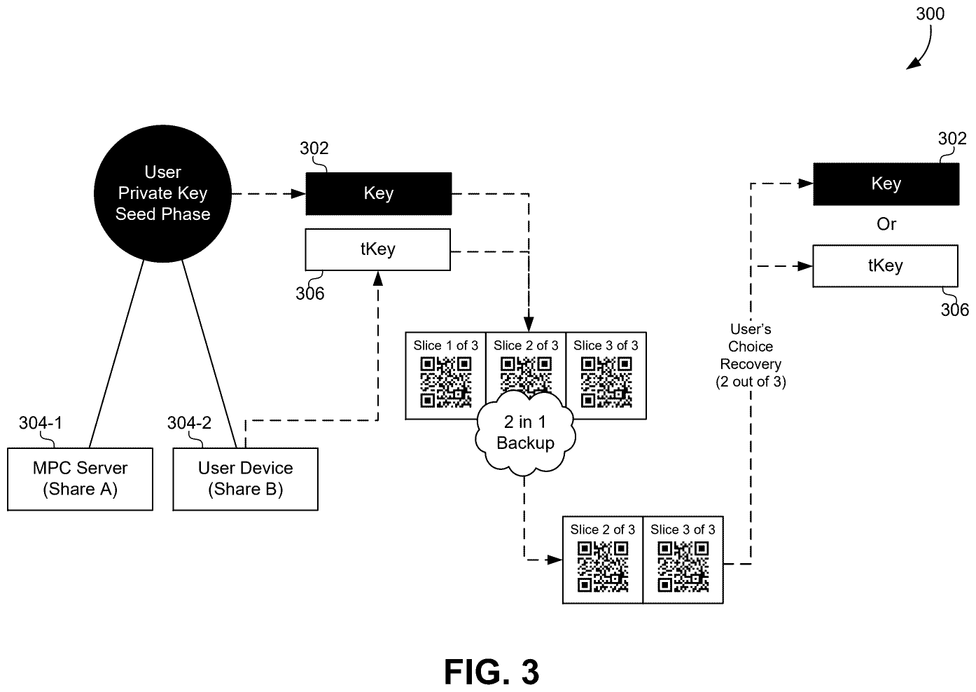

Some embodiments address the concerns and challenges associated with securely storing and managing secret information, such as private keys, by dividing the information into shares, or tKeys, that MPC enabled wallets and techniques can use to sign transactions with or without reconstructing the private key, as well as secure sub-shares that can be used to recover a share and the private key. FIG. 3 illustrates a managed share 304-1 (e.g., share A) and a device share 304-2 (e.g., share B) that may be created from a user's private key 302, according to some embodiments. On their own, neither share could be used to perform transactions. However, MPC may still use the managed share 304-1 and the device share 304-2 to perform transactions.

To provide similar recovery options as a recovery share (e.g., share C), the device share 304-2 may be further divided into a plurality of sub-shares. On their own, none of the sub-shares could be used to recreate the device share 304-2 or another share. However, with a threshold number of sub-shares, the device share 304-2, or tKey 306, could be reconstructed and used by MPC to sign transactions. In this way, if a user were to lose the device on which the device share 304-2 is saved, they could use another device to recreate the device share 304-2 from a threshold number of sub-shares.

In addition to being usable to reconstruct another share, the sub-shares could also be used to reconstruct the private key 302. For example, in addition to dividing a share, or tKey 306, into the sub-shares, the private key 302 may also be divided into the same sub-shares, with a threshold number of sub-shares being required to reconstruct a higher-level share or the private key 302. In some embodiments, the threshold number of sub-shares required to reconstruct a higher-level share is different than the threshold number of sub-shares required to reconstruct the private key 302. For example, if two shares (e.g., the managed share 304-1 and the device share 304-2) are required to sign transactions, then number of sub-shares required to reconstruct one of the shares 304 may be less than the number of sub-shares required to reconstruct the private key 302.

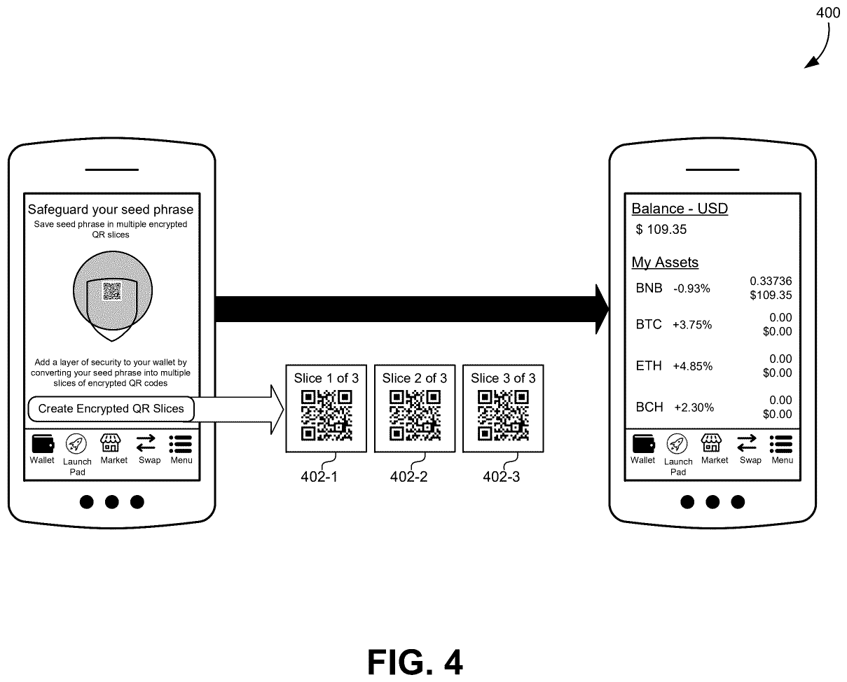

In some embodiments, the sub-shares are encoded in a format that makes it easy for a user to manage, disperse, and safeguard. FIG. 4 illustrates a sample flow 400 a user may follow to generate multiple Quick Response (QR) codes 402, according to some embodiments. Each of the QR codes 402 may represent a part, slice, or unique share, of a user's private key, seed phrase, or other secret information. Each of the QR codes 402 may further represent a part, slice, or unique sub-share, of a higher-level share, such as a tKey. Without a threshold number of QR codes, such as two out of three total QR codes, the user's private key or other share cannot be recovered. While illustrated as three separate QR codes, additional unique QR codes can be generated to increase security. For example, by requiring five out of seven total QR codes, the user's private key and other share may be further protected.

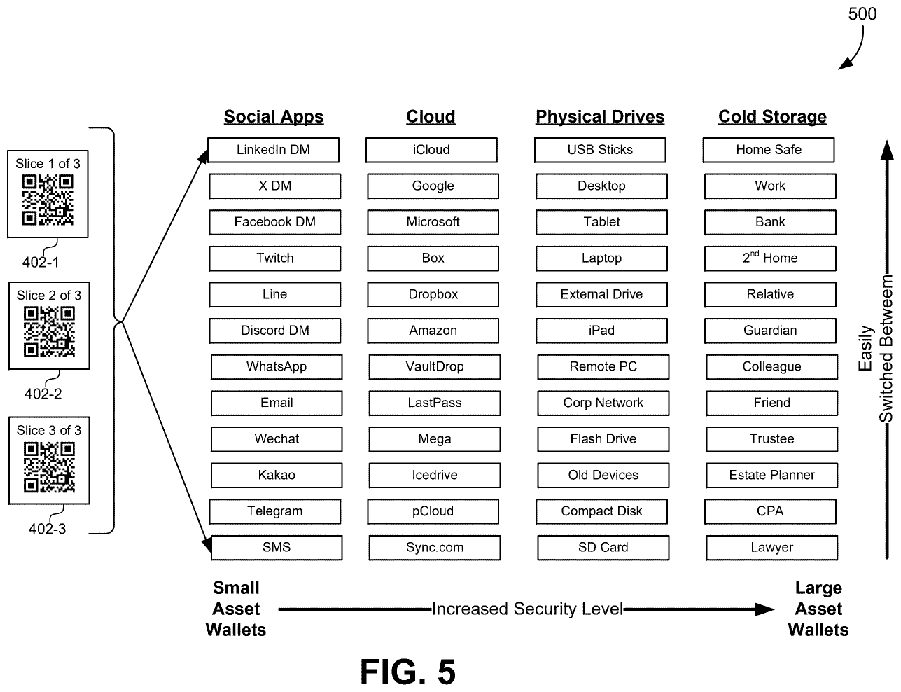

Once generated, the QR code shares may be saved in one or more digital formats, such as a text file, an image file, or the like. Storing shares in this way may allow users to control where and how they are distributed. For example, a user may choose to create a physical copy of a QR code, such as by printing the file containing the QR code on paper. Once in physical form, the digital copy may be deleted and the physical copy may be securely stored in a safe, bank, or other location with physical security measures, much in the same way that a cold-storage wallet may be stored. As another example, a user may choose to send an image containing a QR code via their preferred service, such as in an email, a text message, a social media message, or the like. Additionally, or alternatively, users may choose to save the digital copy of a QR code share on a physical device, such as a hard drive, and/or in a cloud-based file storage system. FIG. 5 illustrates a grid 500 of additional or alternative storage options for the QR code shares, according to some embodiments.

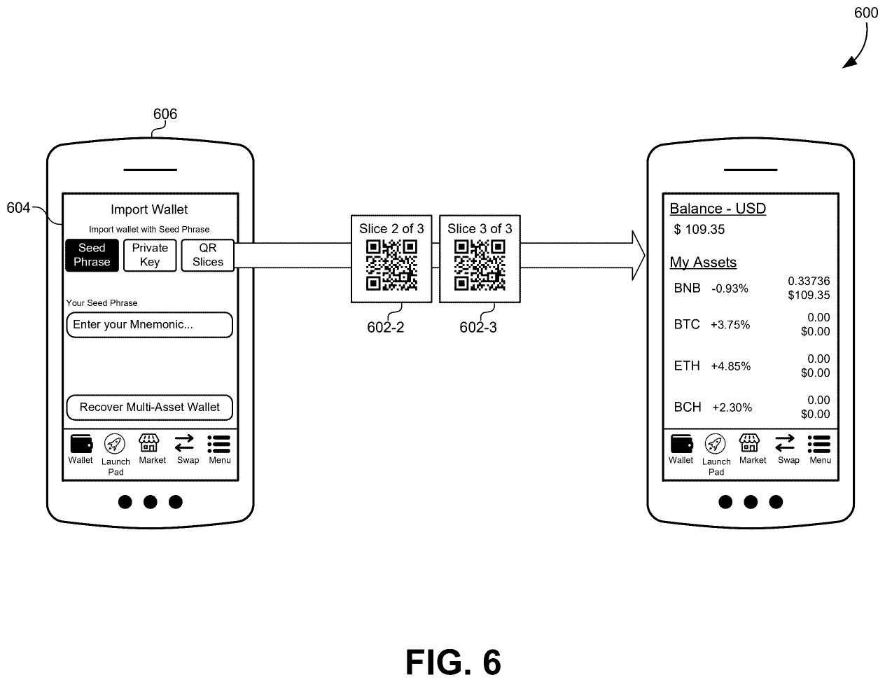

Once securely distributed, a threshold number of QR code shares can be used to recover a user's private information. FIG. 6 illustrates a user flow whereby, when importing a wallet to a wallet management application, the private key used to access the wallet may be recovered by scanning or importing the threshold number of QR code shares 602 into the application 604, according to some embodiments. As described above, the QR code shares 602 may be scanned into the application using a camera of a device executing the application 602 (e.g., from a physical copy), or by selecting a file containing a QR code share from a file system accessible by the device 606 (e.g., locally and/or via the Internet). Once the threshold number of QR code shares have been scanned and/or imported, the application may recover the user's secret information.

QR code shares 602 may be used alone and/or in combination with other types of shares, as described above. For example, in addition to QR code shares 602 being usable to recover a user's secret information, they may also be used to recover a higher-level share of the secret information. Once the higher-level share has been recovered, it may then be combined with other shares, such as a managed share, as described above. For example, the higher-level share, or tKey, may be used in connection with the managed share by an MPC enabled application to sign transactions without using the private key. In some embodiments, a threshold number of shares in addition to the threshold number of QR code shares 602 may be required to recover a user's secret information. For example, the threshold may require the share represented by the QR code shares and one, two, or more shares stored in other locations.

In some embodiments, applications selectively reconstruct and/or use the tKey and/or private key obtained from a threshold number of QR code shares. For example, managed wallet applications that use MPC to sign transactions may automatically extract the tKey from the threshold number of QR code shares. Additionally, or alternatively, wallet applications that are configured to use the private key may automatically extract the private key from the threshold number of QR codes. In some embodiments, both the tKey and the private key are decrypted from the threshold number of QR code shares by an application, which may then select the appropriate one for the function that is being performed. Additionally, or alternatively, applications may selectively decrypt either the tKey or the private key, but not both, to avoid unnecessarily exposing the other piece of information.

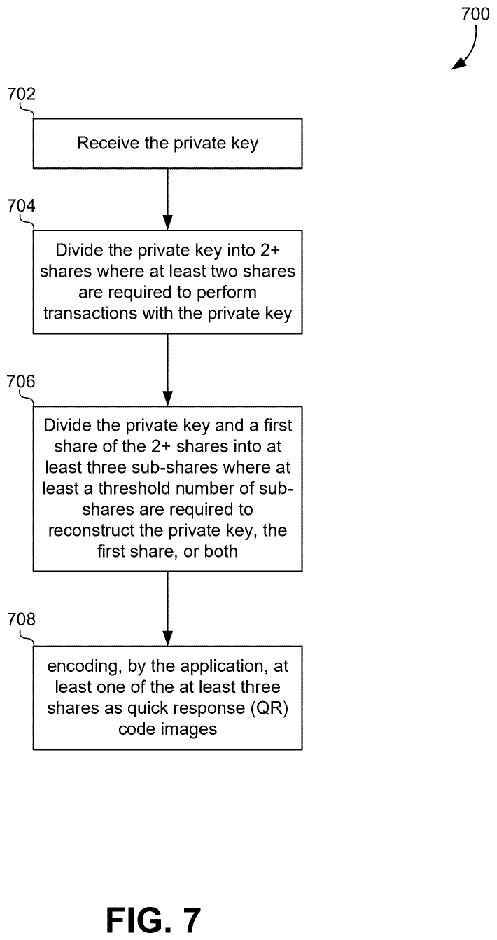

FIG. 7 illustrates a method 700 of securely storing and managing a private key, according to some embodiments. The method may include receiving, by an application executing on a computerized device, the private key (702). The method may also include dividing, by the application, the private key into two or more shares such that at least two shares of the two or more shares are required to perform transactions associated with the private key (704). The method may additionally include dividing, by the application, the private key and a first share of the two or more shares into at least three sub-shares such that at least a threshold number of two or more sub-shares of the at least three sub-shares are required to reconstruct the private key, the first share, or both (706). The method may further include encoding, by the application, at least one of the at least three shares as QR code images (708).

It should be appreciated that the specific steps illustrated in FIG. 7 provide particular methods of securely storing and managing a private key according to various embodiments. Other sequences of steps may also be performed according to alternative embodiments. For example, alternative embodiments may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications. Many variations, modifications, and alternatives also fall within the scope of this disclosure.

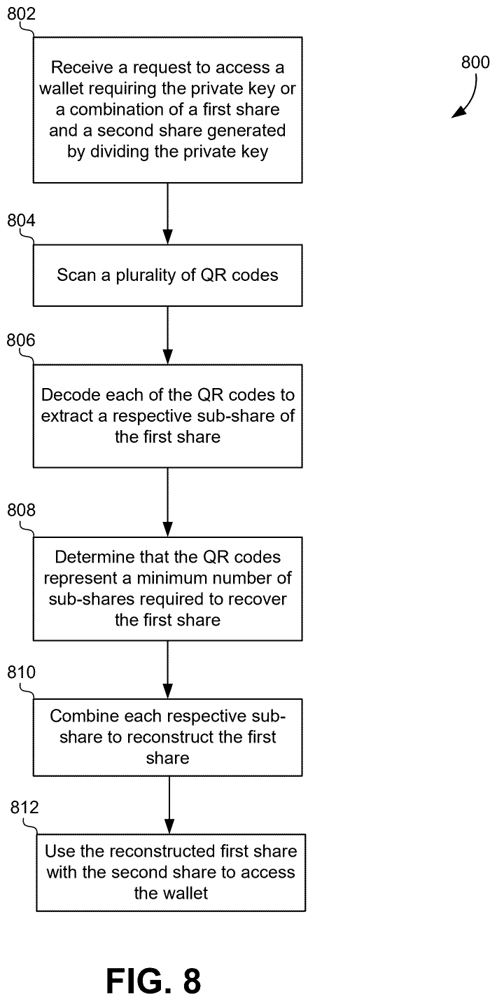

FIG. 8 illustrates a method 800 of decoding a private key, according to some embodiments. The method may also include receiving, at a user interface provided by the application, a request to access a wallet associated with a user of the computerized device (802). Access to the wallet may require the private key or a combination of the two or more shares generated by dividing the private key. The method may also include scanning, by the application, and in response to receiving the request, a subset of the QR code images (804). The method may additionally include decoding, by the application, each of the subset of the QR code images to extract a respective sub-share of the first share (806). The method may further include determining, by the application, and based on information from each respective sub-share, that the plurality of QR codes represents a minimum number of sub-shares required to recover the first share (808). The method may also include combining, by the application, each respective sub-share to reconstruct the first share (810). The method may additionally include using, by the application, the reconstructed first share with the second share to access the wallet (812).

It should be appreciated that the specific steps illustrated in FIG. 8 provide particular methods of decoding a private key according to various embodiments. Other sequences of steps may also be performed according to alternative embodiments. For example, alternative embodiments may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. Many variations, modifications, and alternatives also fall within the scope of this disclosure.

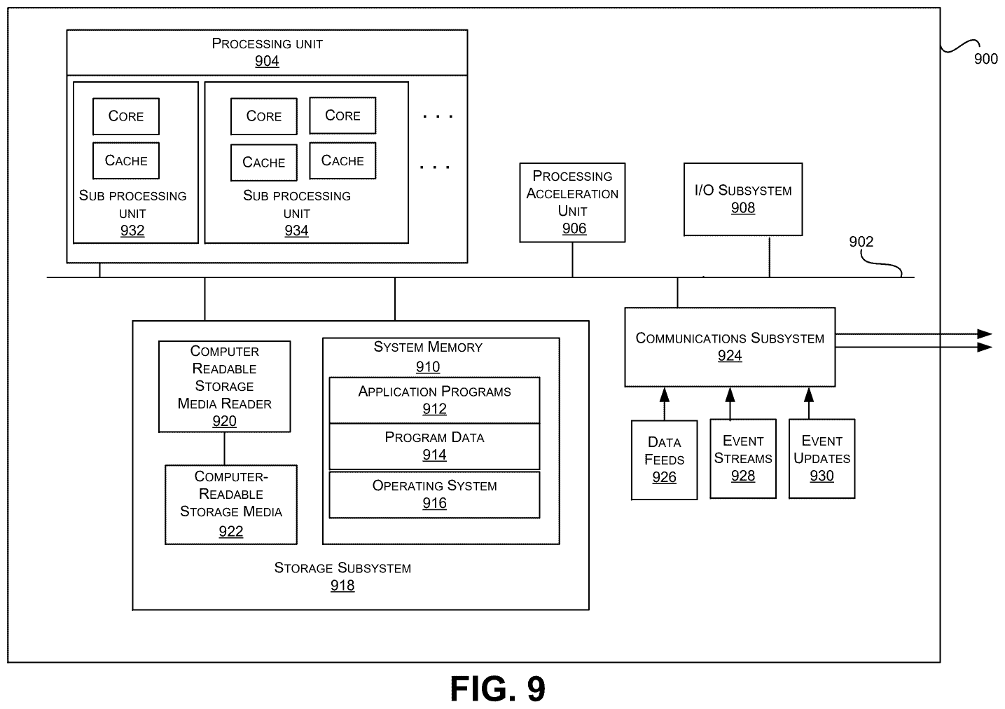

FIG. 9 illustrates an exemplary controller 900, in which various embodiments may be implemented. The system 900 may be used to implement any of the computer systems, processors, controllers, systems-on-a-chip, or other processing means described herein. As shown in the figure, system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, EtherCAT, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processing unit 904 and/or in storage subsystem 918. Through suitable programming, processor(s) 904 can provide various functionalities described above. System 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices.

User interface output devices may include a display subsystem, indicator lights, or non-visual displays such as audio output devices, etc. The display subsystem may include a flat-panel device, such as that using a liquid crystal display (LCD) or plasma display, a projection device, a touch screen, and the like. In general, use of the term “output device” is intended to include all possible types of devices and mechanisms for outputting information from system 900 to a user or other computer. For example, user interface output devices may include, without limitation, a variety of display devices that visually convey text, graphics and audio/video information such as monitors, printers, speakers, headphones, plotters, voice output devices, modems, and/or the like.

System 900 may include a storage subsystem 918 that comprises software elements, shown as being currently located within a system memory 910. System memory 910 may store program instructions that are loadable and executable on processing unit 904, as well as data generated during the execution of these programs.

Depending on the configuration and type of system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with some embodiments.

Storage subsystem 918 may also include a computer-readable storage media reader 920 that can further be connected to tangible computer-readable storage media 922. Together, and optionally in combination with system memory 910, tangible computer-readable storage media 922 may comprehensively represent remote, local, fixed, and/or removable storage devices plus storage media for temporarily and/or more permanently containing, storing, transmitting, and retrieving computer-readable information.

Tangible computer-readable storage media 922 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, including optical storage, magnetic storage, magnetic disk storage or other magnetic storage devices, or other tangible computer readable media. This can also include nontangible computer-readable media, such as data signals, data transmissions, or any other medium which can be used to transmit the desired information, and which can be accessed by computing system 900.

By way of example, tangible computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Tangible computer-readable storage media 922 may include, but is not limited to, flash memory cards, universal serial bus (USB) flash drives, secure digital (SD) cards, disks, digital video tape, and the like. Tangible computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for system 900.

Communications subsystem 924 provides an interface to other computer systems and networks. Communications subsystem 924 serves as an interface for receiving data from and transmitting data to other systems from system 900. For example, communications subsystem 924 may enable system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), and/or other components. In some embodiments, communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use system 900.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to system 900.

Due to the ever-changing nature of computers and networks, the description of system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

As used herein, the terms “about” or “approximately” or “substantially” may be interpreted as being within a range that would be expected by one having ordinary skill in the art in light of the specification. By way of example, these terms may imply a 10% variation above or below a stated value (i.e., “approximately 50” would imply a range between 45 and 55).

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of securely storing and managing a private key, comprising:
receiving, by an application executing on a computerized device, the private key;
dividing, by the application, the private key into two or more shares such that at least two shares of the two or more shares are required to perform transactions associated with the private key;
dividing, by the application, the private key and a first share of the two or more shares into at least three sub-shares such that at least a threshold number of two or more sub-shares of the at least three sub-shares are required to reconstruct the private key, the first share, or both; and
encoding, by the application, at least one of the at least three shares as quick response (QR) code images.

2. The method of claim 1, further comprising generating a digital file comprising a representation of at least one of the QR code images for exporting off of the computerized device.

3. The method of claim 1, further comprising storing at least one of the at least three shares in a memory of the computerized device.

4. The method of claim 1, further comprising:
receiving, at a user interface provided by the application, a request to access a wallet associated with a user of the computerized device, wherein access to the wallet requires the private key or a combination of the two or more shares generated by dividing the private key;
scanning, by the application, and in response to receiving the request, a subset of the QR code images;
decoding, by the application, each of the subset of the QR code images to extract a respective sub-share of the first share;
determining, by the application, and based on information from each respective sub-share, that the plurality of QR codes represents a minimum number of sub-shares required to recover the first share;
combining, by the application, each respective sub-share to reconstruct the first share; and
using, by the application, the reconstructed first share with the second share to access the wallet.

5. The method of claim 4, wherein scanning the plurality of QR codes comprises capturing a digital image of at least one of the QR codes using a camera connected to the computerized device.

6. The method of claim 4, wherein scanning the plurality of QR codes comprises:
receiving, via the user interface, a selection of a digital file from a file system accessible on the computerized device to the application; and
determining, by the application, that the digital file comprises a representation of at least one of the QR codes.

7. One or more non-transitory computer-readable media comprising instructions that, when executed by one or more processors, cause the one or more processors to perform operations comprising:
receiving, by an application executing on a computerized device, a private key;
dividing, by the application, the private key into two or more shares such that at least two shares of the two or more shares are required to perform transactions associated with the private key;
dividing, by the application, the private key and a first share of the two or more shares into at least three sub-shares such that at least a threshold number of two or more sub-shares of the at least three sub-shares are required to reconstruct the private key, the first share, or both; and
encoding, by the application, at least one of the at least three shares as quick response (QR) code images.

8. The one or more non-transitory computer-readable media of claim 7, wherein the operations further comprise generating a digital file comprising a representation of at least one of the QR code images for exporting off of the computerized device.

9. The one or more non-transitory computer-readable media of claim 7, wherein the operations further comprise storing at least one of the at least three shares in a memory of the computerized device.

10. The one or more non-transitory computer-readable media of claim 7, wherein the operations further comprise:
receiving, at a user interface provided by the application, a request to access a wallet associated with a user of the computerized device, wherein access to the wallet requires the private key or a combination of the two or more shares generated by dividing the private key;
scanning, by the application, and in response to receiving the request, a subset of the QR code images;
decoding, by the application, each of the subset of the QR code images to extract a respective sub-share of the first share;
determining, by the application, and based on information from each respective sub-share, that the plurality of QR codes represents a minimum number of sub-shares required to recover the first share;
combining, by the application, each respective sub-share to reconstruct the first share; and
using, by the application, the reconstructed first share with the second share to access the wallet.

11. The one or more non-transitory computer-readable media of claim 10, wherein scanning the plurality of QR codes comprises capturing a digital image of at least one of the QR codes using a camera connected to the computerized device.

12. The one or more non-transitory computer-readable media of claim 10, wherein scanning the plurality of QR codes comprises:
receiving, via the user interface, a selection of a digital file from a file system accessible on the computerized device to the application; and
determining, by the application, that the digital file comprises a representation of at least one of the QR codes.

13. A system comprising:
one or more processors;
one or more storage devices storing instructions that, when executed by the one or more processors, cause the one or more processors to perform operations comprising:
receiving, by an application executing on a computerized device, a private key;
dividing, by the application, the private key into two or more shares such that at least two shares of the two or more shares are required to perform transactions associated with the private key;
dividing, by the application, the private key and a first share of the two or more shares into at least three sub-shares such that at least a threshold number of two or more sub-shares of the at least three sub-shares are required to reconstruct the private key, the first share, or both; and
encoding, by the application, at least one of the at least three shares as quick response (QR) code images.

14. The system of claim 13, wherein the operations further comprise generating a digital file comprising a representation of at least one of the QR code images for exporting off of the computerized device.

15. The system of claim 13, wherein the operations further comprise storing at least one of the at least three shares in a memory of the computerized device.

16. The system of claim 13, wherein the operations further comprise:
receiving, at a user interface provided by the application, a request to access a wallet associated with a user of the computerized device, wherein access to the wallet requires the private key or a combination of the two or more shares generated by dividing the private key;
scanning, by the application, and in response to receiving the request, a subset of the QR code images;
decoding, by the application, each of the subset of the QR code images to extract a respective sub-share of the first share;
determining, by the application, and based on information from each respective sub-share, that the plurality of QR codes represents a minimum number of sub-shares required to recover the first share;
combining, by the application, each respective sub-share to reconstruct the first share; and
using, by the application, the reconstructed first share with the second share to access the wallet.

17. The system of claim 16, wherein scanning the plurality of QR codes comprises capturing a digital image of at least one of the QR codes using a camera connected to the computerized device.

18. The system of claim 16, wherein scanning the plurality of QR codes comprises:
receiving, via the user interface, a selection of a digital file from a file system accessible on the computerized device to the application; and
determining, by the application, that the digital file comprises a representation of at least one of the QR codes.
